(19) United States
(12) Patent Application Publication
(10) Pub. No.: US 2007/0233367 A1
(43) Pub. Date: Oct. 4, 2007

(54) Methods for Interaction, Sharing, and Exploration over Geographical Locations

(75) Inventors: Joseph Chen, Union City, CA (US); Kioma Valenzuela Aldecoa, Boulder Creek, CA (US); Alfred Henry Grebe III, Pleasant Hill, CA (US)

Correspondence Address: EMIL CHANG;LAW OFFICES OF EMIL CHANG, 874 JASMINE DRIVE, SUNNYDALE, CA, 94086, US

(73) Assignee: GEOSPOT, INC., Fremont, CA (US)

(21) Appl. No.: 11/695,582

(22) Filed: Apr. 2, 2007

Related U.S. Application Data
(60) Provisional application No. 60/787,816, filed on Mar. 31, 2006.

(51) Int. Cl. G01C 21/00; G01C 21/32

(52) U.S. Cl. 701/207; 701/200; 701/211

(57) ABSTRACT

The present invention provides key disclosures in three aspects, geo-location information exploration, interaction over geo-locations, and geo-location information sharing. In one aspect, the present invention provides for geo-strolling, a concept of a user navigating to a geographical location on a computer graphically displayed map or environment. The user can be represented by a geo-stroller icon that is visible and programmed for interaction with other geo-strollers present at the same graphically mapped location. This concept is a powerful one because while virtual geo-strollers are not physically located at a place of interest, we can see where their minds are. By tracking the browsing intentions of users, embodiments of the present invention gather information of their interests, making them context compatible for social or business networking as well as other applications.

### PRIORITY CLAIM

This application claims priority from a provisional patent application entitled “Methods of Interaction, Sharing, and Exploration over Geographical Locations” filed on Mar. 31, 2006, having an application No. 60/787,816. This application is incorporated herein by reference in its entirety.

### FIELD OF INVENTION

This invention relates to the field of geographical information, and, in particular, it relates to methods providing for interaction over geographical information and geographical locations.

### BACKGROUND

A large part of the world's information can be directly associated with geo-locations. In the direction of all information being moved from off-line (e.g., books, libraries) to on-line (e.g., search engines, websites) for search, location-associable content can be moved and searched as well. Current consumer mapping websites and mobile location-based services (LBS) offer mostly map information with business services, people and fleet tracking, and first generation social networking. These services and technology offerings provide niche capabilities that span across multiple websites and application providers. Furthermore, portal websites serving millions of users can only stream map image-tiles and limited vector data.

It would be desirable to have a single consumer website or enterprise solution to provide collaboration, tracking, real-time information publishing and effective proximity search. It's further desirable to offer mass-consumer vector-tile streaming and rendering technology with animation capability. The next generation of map and geolocation centric collaboration, information, and services for the millions of users can finally be realized with the complete new design of a technology stack. This stack is made up from a hybrid domains of geographic information system (GIS), location-based services (LBS), content management systems (CMS), gaming, and utilizing advanced web services.

### SUMMARY

An object of the present invention is to provide a user with virtual presence on a map.

Another object of the present invention is to provide for virtual and physical presence where users showing their physical presences on the map can interact with those that are virtually present, creating unique collaboration opportunities.

Another object of the present invention is to provide tools for deep annotations of whole or portions of base-map features such as roads, lakes, cities, hiking trails, college campuses, golf course, railroads, buildings, etc.

Another object of the present invention is to provide for arbitrary attachment to features on the map, including other map features, including trees to hiking trails, BBQ station to picnic tables, office documents to buildings, and pictures and video clips to strollers.

Another object of the present invention is to provide methods for flexible content sharing as users can contribute to publish “what they know” to each distinctive map overlays including “hole-in-the-wall” restaurants, back alley notes, cultural notes on cities, etc.

Another object of the present invention is to provide for realistic moving object simulations including train snap to railroad and cars snap to roads, with moving objects sharing overlays with non-moving features in overlays that can be turned on and off.

Briefly, the present invention provides key disclosures in three aspects, virtual presence of a user over map representing a real world-based geographical location (geo-stroller), interaction among geo-strollers, and geo-location information sharing. In one aspect, the present invention provides for geo-strolling, a concept of a user navigating to a geographical location on a computer graphically displayed map or environment. The user can be represented by a geo-stroller icon that is visible and programmed for interaction with other geo-strollers present at the same graphically mapped location. This concept is a powerful one because while virtual geo-strollers are not physically located at a place of interest, we can see where their minds are. By tracking the browsing intentions of users, embodiments of the present invention gather information of their interests, making them context compatible for social or business networking as well as other applications.

### DRAWINGS

The following are further descriptions of the invention with reference to figures and examples of their applications.

FIG. 1 illustrates User A's screen view with a geo-stroller icon A.

FIG. 2 illustrates User B's screen view with a geo-stroller icon B.

FIG. 3 illustrates User A's screen view and in scrolling a map east to be closer to User B's icon location.

FIG. 4 illustrates User B's screen view, where User A's geo-stroller enters from the left side, heading east.

FIG. 5 illustrates User A's screen view, where User A intends to head in the southeast direction.

FIG. 6 illustrates User B screen view, where User B is idling.

FIG. 7 illustrates User C screen view, where User C is idling.

FIG. 8 illustrates User A moving in the southeast direction towards User C's location.

FIG. 9 illustrates User B's screen view, seeing geo-stroller A moving in the southeast direction.

FIG. 10 illustrates User C's screen view, seeing geo-stroller A rapidly moving in from the northwest, heading in the southeast direction.

FIG. 11 illustrates User A having a built in roll-over message for baby sitting services.

FIG. 12 illustrates User A broadcasting a chat message.

FIG. 13 illustrates User B within range to “hear” the message broadcast by User A.

FIG. 14 illustrates User C being out of range and does not “hear” the message from User A.

FIG. 15 illustrates a geo-spatial tile grid with unique tile identifiers.

FIG. 16 illustrates Stroller A at a geographical area represented by T3.

FIG. 17 provides simultaneous screen views of an interaction between two users in the stranger stage.

FIG. 18 provides simultaneous screen views of two users interacting with each other.

FIG. 19 provides simultaneous screen views of two users interacting with each other using mouse-over or roller over stroller icons.

FIG. 20 provides simultaneous screen views of two users interacting with each other where each other is looking at the other stroller's profile.

### DETAILED DESCRIPTION OF THE PREFERRED EMBODIMENTS

The present invention may be implemented using a variety of technology and/or architecture. In particular, the present invention utilizes scaleable architecture that can be simultaneously accessed by thousands of users supporting the next generation map-based information and location-based services, information that can be implemented by data structures of the present invention and can be manipulated in memory (RAM), run on web browser, desktop computers, mobile phones, PDAs, and in-car navigation/embedded computers, transmitted over network, and stored in persistent devices. The embodiments of the present invention can utilize XML-based technologies as well as including inventions involving enhancement to XML-based technologies.

The following definitions are provided for the purpose of the present disclosure. It shall be understood that the definitions shall not limit the scope of the present invention and are to provide clarity to the descriptions.

A “resource” is a piece of information that can be identified via an identifier over the Internet. It can be a picture, an audio clip, a video, an unstructured text note, an office document, a drawing. It can be structured data with meta data guidance and enforcements such as business contact information, restaurant menus, gas prices, open/close business hours, product descriptions, or attributes on road blocks. It can also be a map object themselves representing land, water, road, railroad, city/state boundaries, houses, golf courses, cemeteries, or any “points of interests” on the map. All resources can be represented as a standard XML document, or in a proprietary binary XML form, or in compact Document Object Model form. A resource in embodiments of the present invention has numerous characteristics and capabilities. The following sections cover each of the major ones that will be used through the document.

“Identifier”. A resource is a piece of information that can be identified via an unique specification, and can be accessed anywhere within a distributed network of computers. This is referred to as the extended Streamable Identifier (XSI) using the internet standard Uniform Resource Locator (URL) to identify a resource along with its properties.

“Access Control”. Sharing rules can be applied at a resource level. The owner of the resource can add users or groups to its access control list or remove them. Each user/group can be granted privileges to read, make changes, or delete. A set of privileges can also apply to the general public.

“Versioning”. A resource can be versioned. Versioning is accomplished by including a version number attribute into the resource object itself, or into its metadata. When a resource is first versioned, the initial version number is 1. Each subsequent version will entail increasing its number by one.

“Time Series”. A resource can also be involved with time. In the embodiments of the present invention time is tracked as a time period. A time period has a pair of time information: beginning and ending. A time period is said to be opened if it has a beginning time but not an ending time. Two types of time periods can be tracked by a resource:

Effective Time Period (ETP)—Refers to the time the resource is within the network of servers and clients. This can be in the past, present, or future.

Relevance Time Period (RTP)—Refers to the time the information applies to a specific time period. This can be in the past, present, or future.

Relationships Among XML Entities

Due to the unique nature of the approach of the present invention to information management of real world objects, special design of how to relate information has to be invented. XML document consists of a top level Element to anchor the entire document, with other Elements added as children. This forms a tree-like structure, and the standard memory data structure representing XML is called the Document Object Model (DOM). Each element may have associations to other XML documents. The associations follow the standard data modeling cardinality of one-to-one, one-to-many, and many-to-many relationships. The associations can be unidirectional (one way traversal), or bi-directional (multi-way traversal).

Proximity Search

The life-line of embodiments of the present invention is the ability to perform any service as long as it is geographical location based. As such, the key mechanism to support search and retrieval of information associated with locations lies with the design of the underlying data structures for memory and storage.

The Tile Grid System

Embodiments of the present invention provide for and utilize tile grids.

Versioned Asynchronous Push/XML (VAPX)

Most systems today employ a typical command/response communication model in a client/server environment. This model supports both synchronous and asynchronous communications. While this model is adequate for today's mapping/LBS functionality, it will not be able to support the functionality required by the embodiments of the present invention.

Features

Feature is a special kind of resource, and can refer to anything on a map that is of interest. It can be a piece of land features like cliff or glacier, a man made road or bridge, a political territory like city or country, a retail business, a tree, a festival event, or a moving object like transportation or people (see motion feature below). Features can be stored and indexed in overlays. The Feature definition is consistent with the terminology generally accepted by the Geographical Information Systems (GIS) community.

Motion Features

The present invention provides a special type of features with movement capability over time. This class of Features include Geo-Strollers, transportation objects, animals, robots, and other features capable of moving. Like regular features, motion features are also under the management of overlays, meaning it can be turned on/off at the overlay level.

Datasets

Dataset is a container for a set of resources. It is capable storing any kind of resource files. The entire dataset can act as a single resource, which means it can have access control, versioning, and time periods apply to it. A dataset may choose to create indices in order to access data faster. Each index is targeted for a specific type of fast looking. An example of an index often used herein is its geo-spatial index (GSI), which is covered below.

Overlays

Overlay is commonly used as information layered over a map. This term will likely to be popularized when geographical information systems and services reach to general consumer users. Here, Overlay is defined as simply a collection of geographical features that can be overlaid on the map as a layer. It can also be shared with proper access control. Since feature resources are associated with location or have geometries, they will be suitable for display, and therefore becoming an Overlay. An Overlay can be virtually composed as several other overlays. Multiple overlays can also be “bundled” into an Overlay Group. Overlays and Overlay Groups have XSI based on URL, so they can be referenced and accessed over the internet.

Overlay Indices

Like database management systems (DBMS), various indexing methods can be used on the data instances in the dataset. The choices of indices (hash, b-tree, and GSI below) depend on the method of fast retrieval and query that the user requires.

Geo-Spatial Index (GSI)

The fundamental indexing method allowing information retrieval over a geographical map is through an implementation of a spatial indexing algorithm. If it is geographical-specific algorithm then it is a geo-spatial index. The present invention provides its own Geo-Spatial Index (GSI) algorithm that is optimal for its use on proximity-oriented retrieval of information.

This GSI is used on any information that can be associated with geographical location. It's main purpose to allow fast search and retrieval of data if a geographical area is known.

Interaction Over Geo-Locations

The embodiments of the present invention provide methods for people to find other people, explore their published information, and interact with them. This section provides the concept and design to convey this exciting new means of social and business networking, public communications involving promotions, and conducting personal and business transactions.

Before getting into the invented concepts, we will first over the terminology of what is discussed in this section.

Geo-Stroller

Stroller in general implies someone who is leisurely walking around with no specific aim of direction or target. A geo-stroller of the present invention follows the same spirit, but may overlaid onto a computer graphically displayed map. A geo-stroller is defined to be an iconic computer graphic character controlled by a real person or computer logic. This graphical character roams/wanders around on a computer-based map. The map, the geo-strollers and points of interest can be displayed on a desktop computer screen as a standalone application or within web browser, on a personal digital assistant (PDA), in a car computer/navigation system, or on a mobile wireless phone.

Physical Geo-Stroller

Physical geo-stroller can be an iconic character representing the user on a computer graphical map at his/her actual geophysical location. Locations of physical geo-strollers can be tracked by 1) mobile devices with position-detection capability, 2) user input of a fixed location by specifying their coordinates or home/business address.

Virtual Geo-Stroller

Virtual geo-stroller represents a user's browsing locations on the computer graphical map. For example, if Joe is physically in San Francisco, but browsing a map of Paris, France, then Joe's virtual geo-stroller icon will appear on the map of Paris, France.

Hardware-Controlled Strolling

Physical geo-stroller icon movements are controlled by signals from a user's physical geographical location. The virtual geo-stroller's movement is a direct reflection of the user's mouse locations in map browsing, or movement requests such as searches.

Software-Controlled Strolling

Software logic can be designed to automate the interactive behavior of virtual geo-stroller movements. Examples of this is implementation of “cyber salesman” who is software guided to target other geo-strollers, or “cyber beggars” asking other geo-strollers for money.

Concept of Geo-Strolling Over the Map

Virtual geo-strolling is the concept of a user navigating to a geographical location on a computer graphically displayed map or environment. The user's geo-stroller icon is visible and programmed for interaction with similar physical geo-stroller and virtual geo-stroller icons present at the same computer graphically mapped location. This concept is a powerful one because while virtual geo-strollers are not physically located at a place of interest, we can see where their minds are. By tracking the browsing intentions of users, embodiments of the present invention gather information of their interests, making them context compatible for social or business networking.

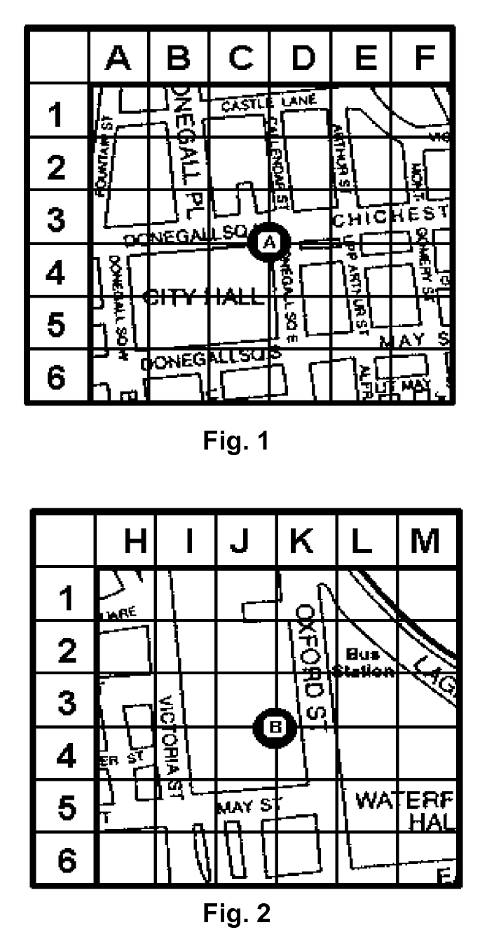

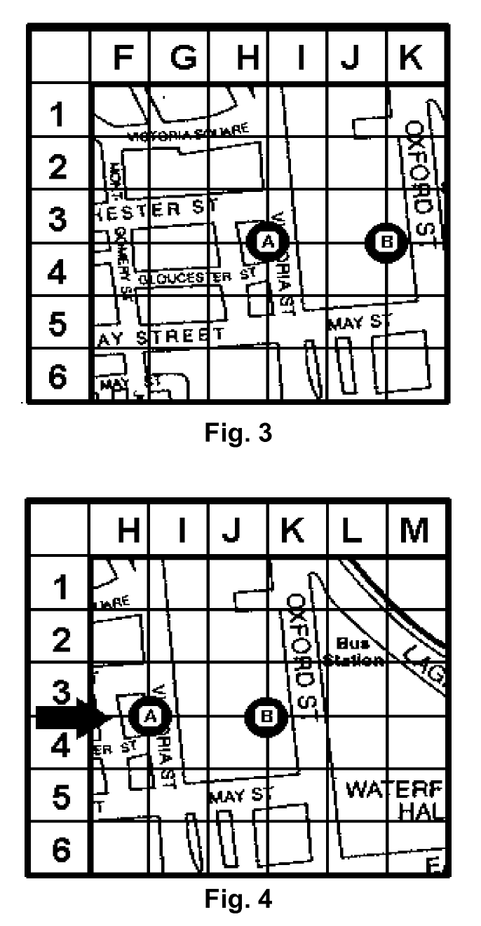

For example, FIG. 1 illustrates User A's screen with a geo-stroller icon A, and FIG. 2 illustrates User B's screen with a geo-stroller icon B. In FIG. 3, illustrating User A's screen view, in scrolling the map east toward User B's icon location, User B's icon appears in the screen, noting that User A's icon “floats” over a fixed position over the map. In FIG. 4, illustrating User B's screen view, User A's geo-stroller enters from the left side, heading east.

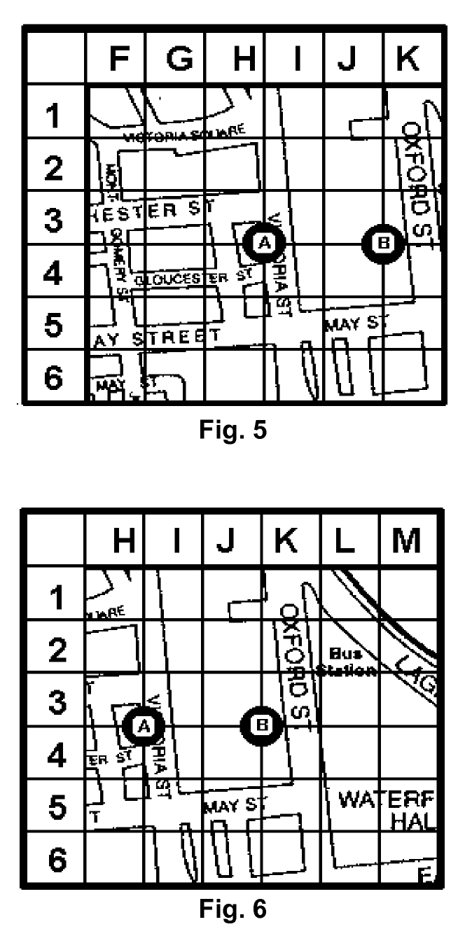

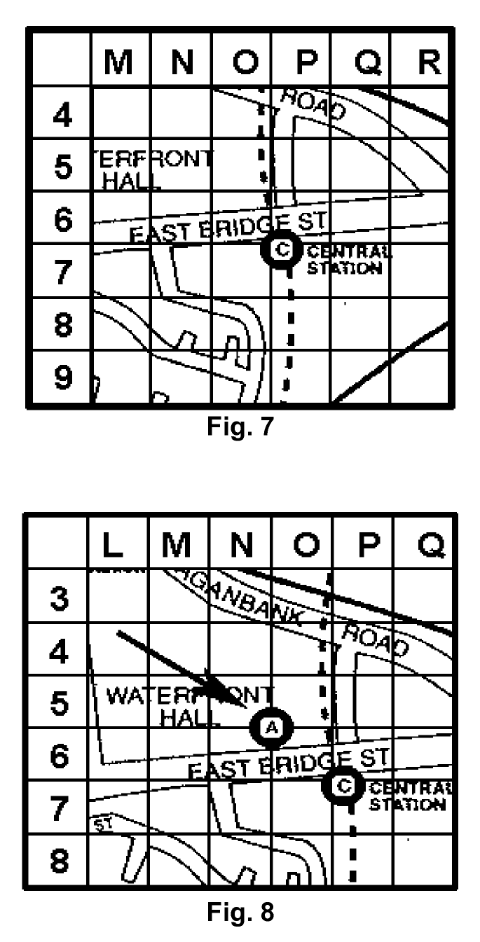

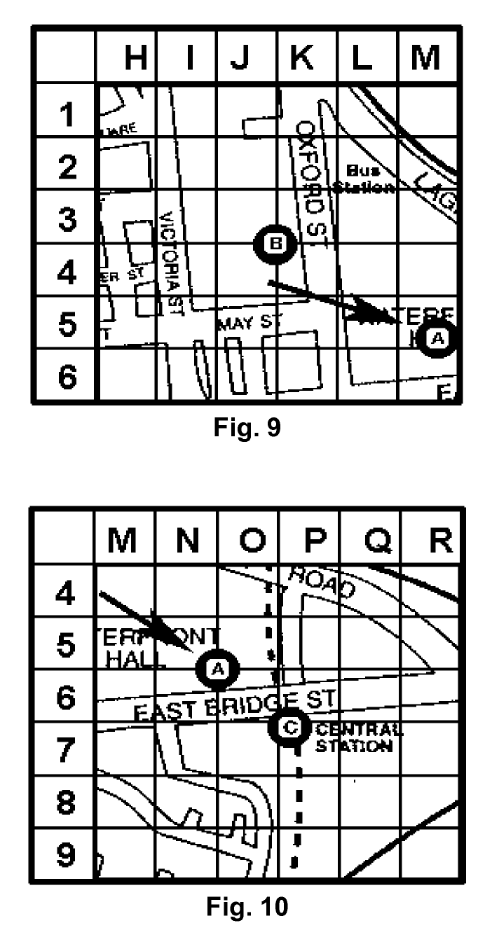

Now, referring to FIG. 5, illustrating User A's screen view, User A intends to browse to the southeast direction. FIG. 6 illustrates User B's screen view, where icon B is idling, and similarly, FIG. 7 illustrates User C's screen view, where icon C is idling. FIG. 8 illustrates that User A moving in the southeast direction toward User C's location, and FIG. 9, illustrating User B's point of view, sees geo-stroller A moving in the southeast direction. User C, referring to FIG. 10, sees geo-stroller A rapidly moving in from the northwest direction and heading in the southeast direction.

Geo-Stroller Movements

The animation of movement of an iconic character over the map is called geo-stroller movement. This movement can vary in speed depending on the distance traveled. For example, moving from one street to another on the same viewable map area can be a slow, subtle movement. Moving to another nearby city off the screen produces a great leap of faster movement. The character flashing and warping to the target location represents moving half way across the world.

Geo-Stroller-to-Geo-Stroller Interaction

A geo-stroller can interact with another geo-stroller, without regard for its virtual/physical status, as well as manually controlled or automatic. One geo-stroller can “mouse over” another geo-stroller to see basic information in a text box, and can click on the “chat” option and begin a conversation in text, audio, or video.

Conducting Transactions

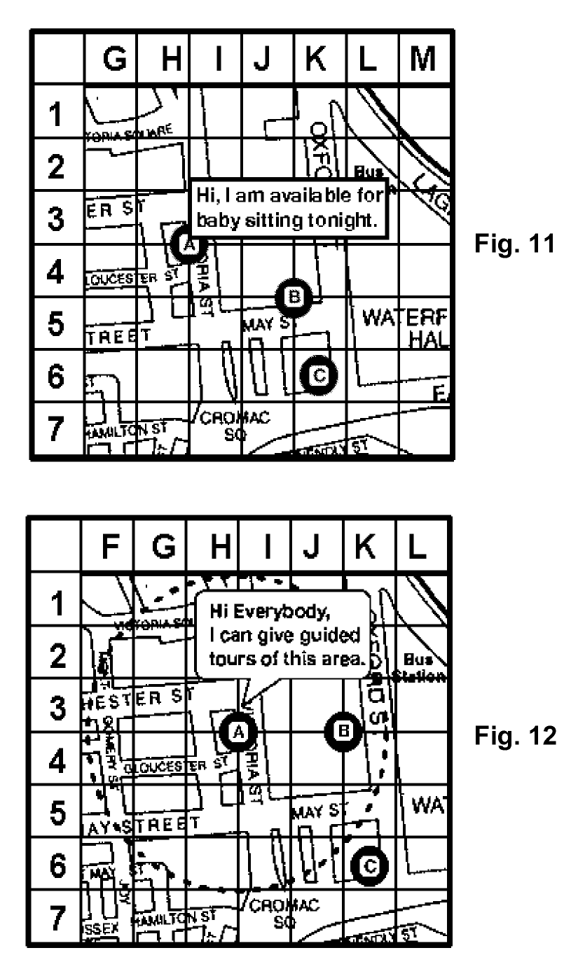

When geo-strollers interact, there is nothing preventing them from conducting a transaction. Using their self promotional capabilities geo-strollers can identify their items/products for sale, as well as services offered. This can be personal items or commercial products to sell. Geo-strollers can also advertise services, such as babysitting, car repair, or carpet cleaning. For example, referring to FIG. 11, User A has a built-in roll-over message for baby sitting services.

Public Broadcasting

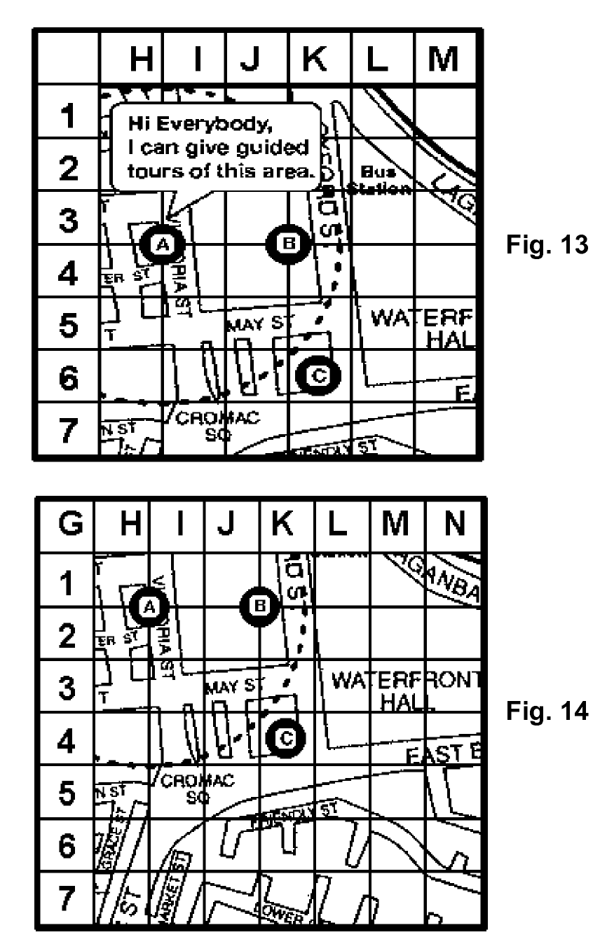

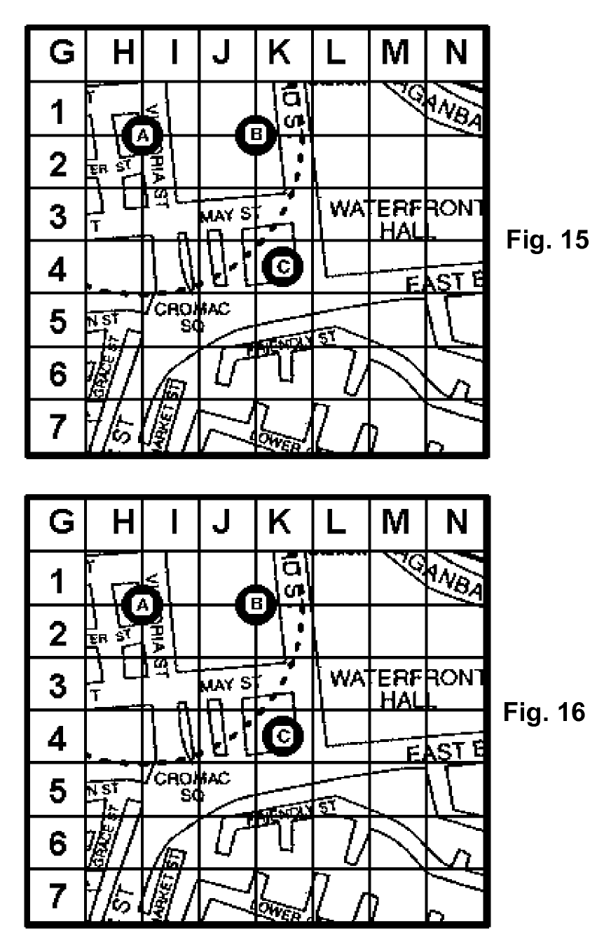

A geo-stroller may arrive at a specific location on the map, and the proceeds to “talk” using provided online chat balloons to display their messages. The messages are not targeted at another geo-stroller, but rather to an area. The system can make the message visible to all geo-strollers within the vicinity of the talking geo-stroller. The distance of message travel can be based on various factors. FIG. 12 illustrates, as an example, User A broadcasts a chat message, and FIG. 13 illustrates that User B is within range to “hear” the message broadcasted by User A, while FIG. 15 illustrates that User C is out of the range and does not “hear” the message from User A.

Time Strolling (Time Travel)

The present invention also provides capability to explore geo-location in respect to time. In addition to explore any geographical location in present time, the geo-stroller can also go back in time in terms of minutes, hours, days, or years. Once the time is determined, the user can use a VCR-like buttons to “play” forward. The user can also go forward in time to explore future/planned events.

One significant and interesting feature is when a stroller go back in time and sees strollers “of the past” strolling, interacting, and doing public broadcasts. It will be an interesting phenomenon to see other strollers from different time strolling around.

Automatic/Robotic Strolling

The geo-stroller movement can be implemented via third-party software logic. Such logic can dictate the behavior consistent with its intended purpose. For example, the software logic can simulate a representation of a non-profit organization, going around asking for donations. In another example, software logic can move a plane or blimp, showing intrusive but entertaining advertisements. Lastly, a geo-stroller can be programmed as a “salesman” character, like a Mickey Mouse telling geo-strollers in the Southern California area to go to Disneyland, or a car salesman character broadcasting deals within certain range.

Design

Tile-Based Tracking

To make strolling over map possible, the underlying design must include a geospatial index method that breaks up Earth into tiles. Each tile covers a specific geographical area. The actual size of the tiles and number of tiles are not relevant to this invention, except that they may be of a rectangular shape projected onto the earth sphere.

The strollers are Features that can move over time. Since a Feature is a Resource, it automatically inherits attributes to track various versions and time periods. The time period that that can be used is the effective time period (ETP).

FIG. 15 illustrates a plain geospatial index using tile concept. Each tile represents a square or rectangular region on earth. The coordinate system is not relevant here, and the size can vary depends on how much features to be stored in each tile.

Each tile may have a unique identifier (or key). It is capable of storing information about any features (e.g., roads, buildings, retail business, etc) located in a geographical region represented by a tile. And since geo-strollers are features that simply move in respect to time, we can use the tiles to hold strollers. The example shows a stroller who happens to be in the area assigned to Tile 3 (T3). FIG. 16 illustrates Stroller A at a geographic area represented by T3.

Stroller-Interactivity

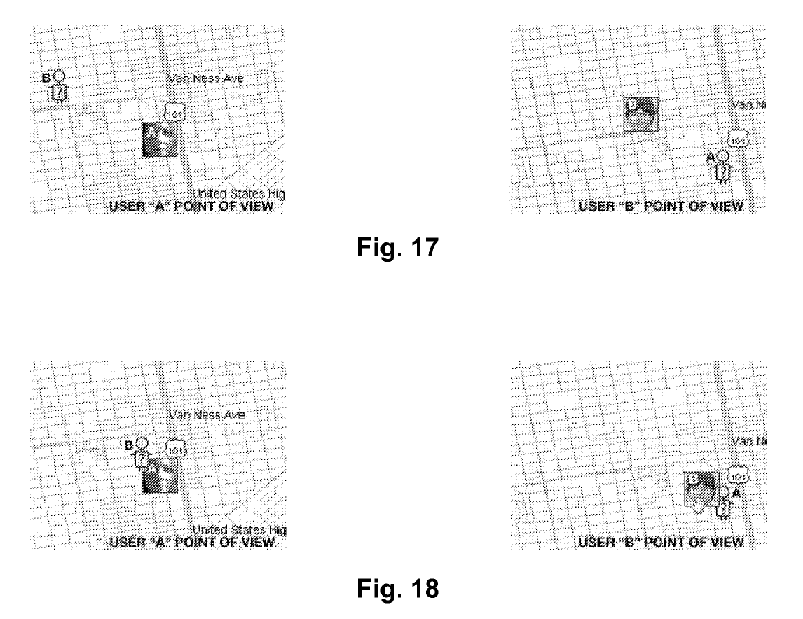

In another illustration of an embodiment of the present invention, referring to FIGS. 17-20, a user experience, his/her view of the stroller icon on a map, and how other users appear to each other are presented. Referring to FIG. 17, when first logging in, User A's icon appears at the center of the map, and the same is for User B in his map viewport.

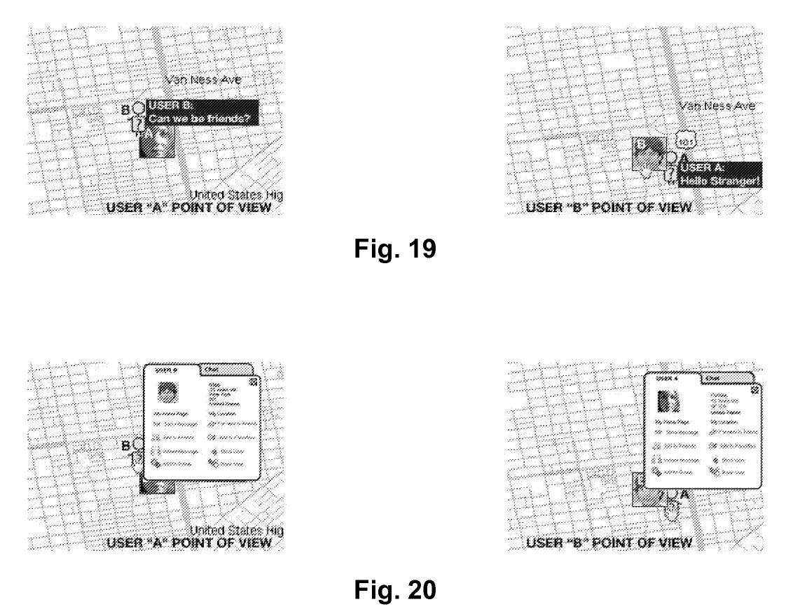

Referring to FIG. 18, User B appears to be a “stranger” or appears as a default generic icon to User A. In the same way, User A appears to be a “stranger” to User B. They have not yet become known or “friends” to each other. Referring to FIG. 19, here User B is dragging his icon to be in contact with User A's icon. Referring to FIG. 20, the intersection, as well as a mouse-over or rollover another stroller icon, reveals a basic message, which can include a User ID and a greeting message.

Clicking with a mouse-down on another stroller icon reveals the full profile and contact links of the user. Here we see User A is looking at User's B's profile, while User B is looking at User A's profile.

This is a simple list of things strollers might do to interact with each other.

For n-ary operations (in some sense this includes most unary operations), it may include: chat with a specific person or group of people, show someone a picture, make an insulting gesture, generally broadcast, add an annotation on an object, bat eyelashes, grin (the ‘evil grin’ of shaedenfreude), smile, express sadness, cry, wink, flirt (some binary thing similar to it), act confused, act love struck, blush, express distaste or disgust, playful, rather than insulting, insulting gesture (e.g. sticking out tongue, which has usually become playful), express the sadness of a broken heart, express mild surprise, express astonishment or panic, express anger, act worried, express relief, produce a (halo, horns, wizard cap, fake mustache, cowboy hat, etc) and put it on, remove object put on, laugh, laugh uproariously (‘ROTFL’), play an uploaded animation (‘audible’ type thing), play miniature golf, write graffiti, and get rolled over.

For binary operations (requires action of both parties), it may include the following interactions: kiss, intimacy, pass a file, hug, dance (which may include the different styles), fight, do the ‘hello sailor’ bit, and share a whiteboard.

With respect to intimacy, a control can be included that is set in accordance with each user's control panel, which can include an ordered set of levels from ‘handshake’ to ‘passionate kiss’. Each user sets their intimacy level without revealing it to the other, and the strollers can visually do the minimum of the two levels. This is less socially awkward than the real or IM style ‘we chat, I say goodbye, the guy tries to kiss me, I respond with a hug’.

In providing further explanation of the present invention, the following descriptions are provided.

Note that objects can be anything, including roads, bridges, buildings, people, businesses, events, trees, signs, dead animals, services, etc.

“Chatting in Public” or “Public Conversations” is where someone says something and anyone within the vicinity can see/hear the broadcasted message in text, images, audio, or video.

Information can be played back in such as a way that as if “going back in time” where moving objects moving that time will be replayed the same, and open hours or business promotions are the same. The forum postings will have as much information as known to that period of time.

With respect to annotating the map includes annotating any objects on the map including roads, trees, signs, buildings, cities, countries, water bodies, businesses, events, and moving objects such as people, animals, vehicles, or cyber robots.

In providing for overlay, a user can add a user-defined map over the map, which is defined by other users. Users can include end users or commercial content providers such as mapping companies, media/news companies, and any other having information on locations.

Note that pre-defined location can refer to (1) the physical location of the user as specified by the user; (2) the physical location of the user with assistance from positioning services such as GPS on mobile devices, cell-site triangulation, RFID or Bluetooth; or (3) the geo-location where the user is browsing over the map where this can denote where the user's mind set (or mentally) is at.

Further note the emphasis on “mind set” or mental presence where a user can be strolling the map and be attracted to an event at a particular location and visits that location and interacts with other users and objects at that location. For example, a user can mentally stroll on the L.A. area and discovers that the Oscar Awards are/were being presented at that time (or at a previously recorded time) and strolls to that location to star watch. That user can then interact with the other users (physical or mental) and/or objects (actual or virtual) in enjoying the event.

In the implementation of the embodiments of the present invention, point-of-interest includes real-time updating of all user screens. Also, real-time address changes would be updated immediately as well. This platform provides for geo-location based games such as full-motion or animation virtual drag-racing (that can be snapped to geometry), where events can be input to (or into) any objects. The temporal ability of the present invention provides a history of interaction allowing full motion recording and playback, thereby providing a history over time.

The interactive map engine of the present invention can be vector-based and on clients, including true object-on-map interaction, true moving object motions, object/road highlight capability, integer coordinate math (works on phones), true zoom, architected to accommodate 2.5D and 3D, multi-language support (limited on phones), private label-capable for websites, embeddable Java applet <500 KB in size, and flash versions.

Furthermore, the embodiments of the present invention provides the following features, including but not limited to user-defined overlays, anything is selectable, anything can be highlighted, anything can be annotated, anyone can create maps, customizable layers/skins, map-on-map inclusion, true motion animation, real-time temporal events, real-time proximity alerts, virtual social networking, unique advertising paradigm, real-time road updates, real-time address changes, geo-location game-ready, temporal associations, dynamic categorization, and multi-language labels/search.

Latch-On

A stroller, such as a human-based or a computer logic robot, can be latched on by one or more users (latchers) such that when the stroller being latched on by (latchee) moves on the map, everyone who latched on will move with the latchee. When the latchee zooms into or out of the map, so well all the latchers, and when the latchee or latchers speaks with text or audio, everyone in the group will see and hear. When a user wishes to leave the tour, it can latched off the tour guide and move independently. A real example of this is the latchee playing the role of a tour guide, giving introductions of places and features to the latchers. The latchee can be a computer-logic controller robot (“tourbot”). With this feature, tour guides for certain geographical areas can be provided where a visiting user to that geographical area can latch on a tour guide and the tour guide will provide a tour of the local sights and sceneries to the visiting user. Also, “cyber salesmen” can engage with strollers on the map, or banner and pop-up ads can be provided over certain geographical areas on the map.

Avatars

Each user can be represented by an avatar that may be a still image and/or an animated icon. The avatar can represent the particular characteristics or trait or emotion of the user at that time. For example, the avatar can be of certain size or shows the symbol of a particular political party or football team, etc. The avatar can be searchable based on the particular trait or emotion. Secondary image or banner can be added to the primary avatar described above. For example, for a particular holiday such as the independence day, a secondary icon showing an American flag can be added to the primary avatar.

Map Inclusion

In the embodiments of the present invention, maps can include other maps. Here, a point-of-interest on a primary map can be clicked and this point-of-interest would expand into another map or group of maps. Each of these maps would also have points-of-interests each expandable to one or more maps with points-of-interest. For example, a shopping mall is a point-of-interest on a map. Upon clicking this point of interest, each level of the shopping mall can be displayed as one or more maps, and the parking garage can be another map as well.

Overlays

Each map may contain one or more overlays or no overlays at all. While all the overlays may be displayed on a map, filtering options can be provided to allow users to select overlay of interest and only interact with those overlays of interest. The access and control to each overlay can be managed as well. For example, a group of friends may manage a group of overlays that only members of the group may access, display, annotate, etc. Community overlay allows everyone to mark up on that map, add objects, or attach documents.

Other methods for filtering information and/or overlay are provided as well. For example, purpose driven filtering methods are provided to allow purpose-based filtering. For example, this type of filtering would provide for going to work, going shopping, hunting for a house, etc., where a task is purpose driven. Another type of filtering method is mood driven filtering where filtering is performed based on emotion such as happiness, sadness, romance, in-love, etc.

Jurisdiction Control

Jurisdiction control provides boundaries over geographical areas. This is particularly useful where large national/international organization wants to present a uniform set of overlays to end users everywhere, but there is a need to associate the territorial responsibilities for content and services for it's local affiliates. For example, a relief agency such as American Red Cross may draw up boundaries over geographical areas and assign each geographical area it's local chapters to provide regional content (blood drive centers with open/close hours), as well as handle all services (e.g., donations and volunteer requests). These jurisdictions may be dynamically drawn and re-drawn in real-time and assigned and reassigned depending the availability of resources (as well as other factors) and political decisions. Thus, the present invention provides for tools that would allow the delineation of jurisdiction and assignment of jurisdiction to particular user or group of users. Thus, all of the teams would be looking at the same data and understand their areas of responsibility.

Furthermore, as another example, a large national television network with local affiliates, with the embodiments of the present invention would allow the organization to present a uniform view of map with a consistent set of overlays including: local programming, national news, local news, sports, events and calendar, food reviews, classifieds, traffic and weather. Taking an example of a well known national media company American Broadcast Company (ABC), a user is in San Francisco, for example, he will get the “ABC” overlay group with contents from KGO, which is an affiliate of ABC network. When the user pans the map with the “ABC” overlays active to Los Angeles, all associated “ABC” overlay content and services will shift to KABC as the provider of the content while ABC parent maintains it's consistent view.

Vector Based

It is important to note that the maps utilized by the embodiments of the present invention are vector based such that full manipulation of the objects and maps are allowed. For example, on all consumer websites using map, the map data streamed are image-tiles. The images contain the base map including roads, railroads, lakes, land/surfaces, and city/state/country boundaries. Because they are images, it's not feasible to allow user to select one of these base map objects to highlight, annotate, attach files, or even edit them. The embodiments of the present invention include vector-tile technology streamed to millions of users.

Attachment Architecture

Given the vector based architecture, information and/or objects and features can be associated to certain designed areas. For example, with respect to road condition, it can be assigned to certain 5 blocks of that road that is affected by the road condition. Also, the location information is not restricted to GPS readings and standard coordinate system like longitude and latitude. It also does not restrict to also the need of having a physical postal address. Attached information/documents, services, events, businesses, or other physical objects like buildings or trees can have an “inferred location” based on descriptions such as a piece of news to “Northeast of Iraq Capital” or “2 days after and 3 miles Northeast of the Suicide Bombing next to the black light pole.”

Location Based Contextual Advertising

Since the information with respect to each user is known, as well as the travel patterns and/or direction or areas of interest, contextual ads can be targeted to each user. For example, if a user on the desktop signs on in Beijing China but now browsing Los Angeles, proper advertising filtering may result in “travel package for two from Beijing to LA” posted in Chinese.

Glossary of Terms

This section attempts provide a quick description of terminologies used in the document.

“AJAX” means synchronous JavaScript And XML.

“ETP” means Effective Time Period—Refers to the time the resource is within the GeoSpot network of servers and clients. This can be in the past, present, or future.

“Feature” is a term used within the GIS domain to specify an entity associated with the physical world that is worth noting. This can include streets, highways, a park, a well-known area, etc. To general end users, a Feature can be a POI.

“GeoSpot” identifies with a location. A term invented and meant to be popularized with the venture.

“Geo-Stroller” means an entity representing a real or virtual person controlled by a real person or computer logic that roams/wanders around on a computer graphic map.

“GIS” means Geographical Information Systems, an area of study pertinent to information associated with earth.

“LBS” means location-based services. A term used to describe any technology and/or on-line or mobile services involving with the geographical location of the user.

“Overlay” means grouped information that can be presented on a map.

“POI” means point(s) of interest. It applies to anything physically present at a location that is of interest to someone. Standard known POI includes hotels, restaurants, ATM machines, etc. POI can be virtual and created by a user as well.

“RTP” means relevant time period, referring to the time the information applies to a specific time period. This can be in the past, present, or future.

VAPX means versioned asynchronous push with XML. A technology for “pushing” information to clients.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A method for providing geographic information, location-based services, comprising the steps of:
providing a map representative of a world-based geographical area with points of interest, wherein said map comprises of a plurality of tiles, where each of said tiles represents a portion of said geographical area and each of said tiles containing one or more objects and information regarding the objects;
placing an icon representing a first user on said map, said first user capable of strolling on said map;
presenting to said first user one or more objects from a selected area of said map; and
allowing interaction between said first user and the objects from the selected area.

2. The method as recited in claim 1 wherein the icon representing said first user is placed on said map based on the geographical location of said first user.

3. The method as recited in claim 1 wherein the icon representing said first user is placed on said map based on a pre-defined location as defined by said first user.

4. The method as recited in claim 1 wherein the objects include one or more additional users, gas stations, restaurants, stores, buildings, and streets.

5. The method as recited in claim 1 wherein said first user interacts with a second user.

6. The method as recited in claim 5 wherein said interaction includes conversation, chat, text messages, public conversations and voice calls.

7. The method as recited in claim 1 wherein the objects and the map change over time.

8. The method as recited in claim 7 wherein information regarding the objects and the map are recorded over time.

9. The method as recited in claim 8 wherein the recorded information of the objects can be played back.

10. The method as recited in claim 7 wherein information regarding the objects and the map are tagged for a future time period and information regarding the objects and the map for the future time period can be illustrated.

11. The method as recited in claim 9 wherein the recorded information of the objects can be played back in reverse.

12. The method as recited in claim 1 wherein a user can add an object to the map.

13. The method as recited in claim 1 wherein a user can add an object to another object.

14. The method as recited in claim 1 wherein an object can be linked or attached or added to another object.

15. The method as recited in claim 1 wherein a user can annotate the map.

16. The method as recited in claim 1 wherein a user can add a user-defined overlay to the map.

17. The method as recited in claim 1 wherein a user can add a user-defined map over the map.

18. The method as recited in claim 1 wherein an object can be selected, viewed, and annotated.

19. The method as recited in claim 1 wherein advertisements can be presented to a user as a function of the user's information.

20. The method as recited in claim 5 wherein the first user interacts with the second user, wherein the location of the first user is based on the geographical location of the first user and the location of the second user is based on a predefined location defined by the second user.

21. The method as recited in claim 5 wherein the first user interacts with the second user, wherein the location of the first user is based on a user-defined location defined by the first user and the location of the second user is based on a user-defined location defined by the second user.

22. The method as recited in claim 3 wherein the first user strolls on the map and interacts with neighboring objects.

23. The method as recited in claim 2 wherein the first user strolls on the map and interacts with neighboring objects.

24. The method as recited in claim 1 wherein the interaction includes social networking, business networking, buying and selling, trading, soliciting, broadcasting, talking in public, and exchange of information.
